(19) United States
(12) Patent Application Publication
(10) Pub. No.: US 2005/0274583 A1
(43) Pub. Date: Dec. 15, 2005

(54) Tension spring arrangement

(75) Inventors: Michael Hewel, Boppard Udenhausen (DE); Marcus Weber, Neuwied (DE)

Correspondence Address: COHEN, PONTANI, LIEBERMAN & PAVANE, 551 FIFTH AVENUE, SUITE 1210, NEW YORK, NY, 10176, US

(73) Assignee: Stabilus GmbH

(21) Appl. No.: 11/139,144

(22) Filed: May 26, 2005

(30) Foreign Application Priority Data
May 26, 2004 (DE) 10 2004 026 356.6

(51) Int. Cl. F16F 5/00

(52) U.S. Cl. 188/322.19

(57) ABSTRACT

A tension spring arrangement includes a pneumatic spring configured with a cylinder, which has a closed end coupled to a motor-vehicle body, and a piston and rod unit coupled to a hatch and operated so that when the piston and rod unit is displaced in the cylinder to a first position, the hatch is swung to a generally vertical open position, and when the piston and rod unit is displaced to a second position, the hatch is swung to a substantially horizontal closed position. The piston is shaped and dimensioned so as to define two cylinder chambers, which are in flow isolation upon displacement of the piston and rod unit toward the first position, and are in flow communication and under a substantially uniform pressure upon displacement of the piston and rod unit to the second position.

### BACKGROUND OF THE INVENTION

1. Field of the Invention

The invention pertains to a tension spring arrangement for a hatch on a motor vehicle.

2. Description of the Related Art

It is known that a helical tension spring can be used as the tension spring for opening and closing a motor vehicle hatch. These helical tension springs take up a large amount of space, are vulnerable to corrosion, and produce annoying rattling noises while the vehicle is being driven.

A need therefore exists for a tension spring arrangement providing for pivoting of the hatch and having a simple design.

A further need exists for a tension spring arrangement utilized for operating the hatch that has a space-effective configuration and operates in a substantially noiseless manner.

### SUMMARY OF THE INVENTION

This task is accomplished according to the invention in that the tension spring has a cylinder closed at one end. The interior space of the cylinder is filled with a gas and is divided by a piston mounted with freedom to slide back and forth inside the cylinder into a first working chamber and a second working chamber, which are sealed off from each other by the piston. The piston rod, one end of which is attached to the piston, extends from the second working chamber through a seal to the outside. The outward-projecting end of the piston rod forms one end of the spring, whereas the closed end of the cylinder forms the other end of the spring. When the piston is in a certain position near one end of the cylinder, i.e., a position which corresponds to the closed position of the hatch, the same pressure, especially atmospheric pressure, prevails in both working chambers.

This design results in a tension spring of compact dimensions, which avoids annoying rattling noises by providing precise guidance for the various components of the tension spring.

When the hatch moves from its closed position, in which at least approximately the same pressures are present in both working chambers, into its open position, the pressure in one of the working chambers increases, while it possibly decreases in the other chamber. These changes in pressure produce a force which acts on the piston and on the piston rod in the closing direction of the hatch.

This force, which increases as the hatch is being opened, slows down the opening movement, and when the hatch is being closed, it assists the closing movement.

The first working chamber can be connected permanently to the outside air by a first recess, whereas the second working chamber can be connected to the outside air by a second recess when the piston is in a certain position near one end of the cylinder.

Thus, when the hatch is being opened, the pressure starts to increase in the second working chamber as soon as the piston has traveled past the second recess and the second working chamber is therefore no longer connected to the outside air.

So that the pressure in the working chambers can be equalized in the closed position and the piston thus relieved of load, the first working chamber is or can be connected to the other working chamber though the second recess when the piston is in a certain position near one end of the cylinder.

There is not only an increase in the pressure in the second working chamber but also a decrease in the pressure in the first working chamber.

The moment at which the pressure starts to increase is determined by the length of the second groove-like recess and the end pointing toward the second working chamber. The change in the cross section of the groove over its length determines the course of the pressure equalization between the two working chambers.

The position of the second recess determines the moment at which the pressure will start to increase in the second working chamber.

If more-or-less atmospheric pressure prevails in the interior of the cylinder when the working chambers are connected to each other, there is no need to fill the interior of the cylinder with pressurized gas during the production of the tension spring.

A connection between the two working chambers when the piston is located near one end of the cylinder can be easily established by forming a groove-like recess in the inside wall of the cylinder near the axial end; the length of this recess in the axial direction is longer than the axial dimension of the sealing area of the piston.

If the end area of the cylinder in which the two working chambers are or can be connected to each other is the area at the closed end of the cylinder, then, when the hatch is in the closed position, the piston rod will be located almost entirely within the cylinder and thus protected from damage and dirt. In addition, the space required to accommodate the tension spring will therefore be substantially minimized.

If the hatch can be swung around the pivot axis from a more-or-less vertical closed position into a more-or-less horizontal open position, then, while the hatch is being opened, the outward movement of the piston rod from the cylinder and the increase in the effect of gravity acting on the hatch have the effect of increasing the supplemental force acting in the closing direction.

A good damping of the opening movement combined with a force assist during the closing of the hatch can be achieved by attaching one end of a motion-damping element acting in parallel with the tension spring to the body and by attaching the other end to a linkage point on the hatch. Preferably, the motion-damping element can be an oil damper.

An exemplary embodiment of the invention is illustrated in the drawing and described in greater detail below.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

FIG. 1 shows a longitudinal cross section through a tension spring in the closed position of the hatch; and

FIG. 2 shows a longitudinal cross section through the tension spring according to FIG. 1 in the open position of the hatch.

### DETAILED DESCRIPTION OF THE PRESENTLY PREFERRED EMBODIMENTS

The tension spring shown in the figures has a cylinder 1, which is closed at one end, in which a piston 2 is mounted with freedom to move back and forth in the axial direction. The outer surface of the piston is radially spaced from the inner surface of the cylinder so as to define an annular groove 3. A sealing ring 4 is inserted into the annular groove 3 and rests tightly against the inside wall 5 of the cylinder 1, thus dividing the interior space of the cylinder into a first working chamber 6, which is in flow communication with atmosphere through a first recess 20, and a second chamber 7.

One end of a piston rod 8 is attached to the piston 2 so that on its way out of the cylinder 1, this end of the rod passes through the second working chamber 7 and through a guide and sealing unit 9, which seals the second chamber 7 off against the outside. The outer end of the piston rod 8 is attached to a diagrammatically shown linkage point 40 of a hinge or multi-hinge joint on the hatch of a motor vehicle. The closed end of the cylinder 1 is attached to a diagrammatically shown linkage point 50 on the body of the motor vehicle.

The outward movement of the piston rod 8, which corresponds to the opening movement of the hatch, is limited by a stop, which is formed by a circumferential pleat 10 projecting radially inward into the second working chamber 7.

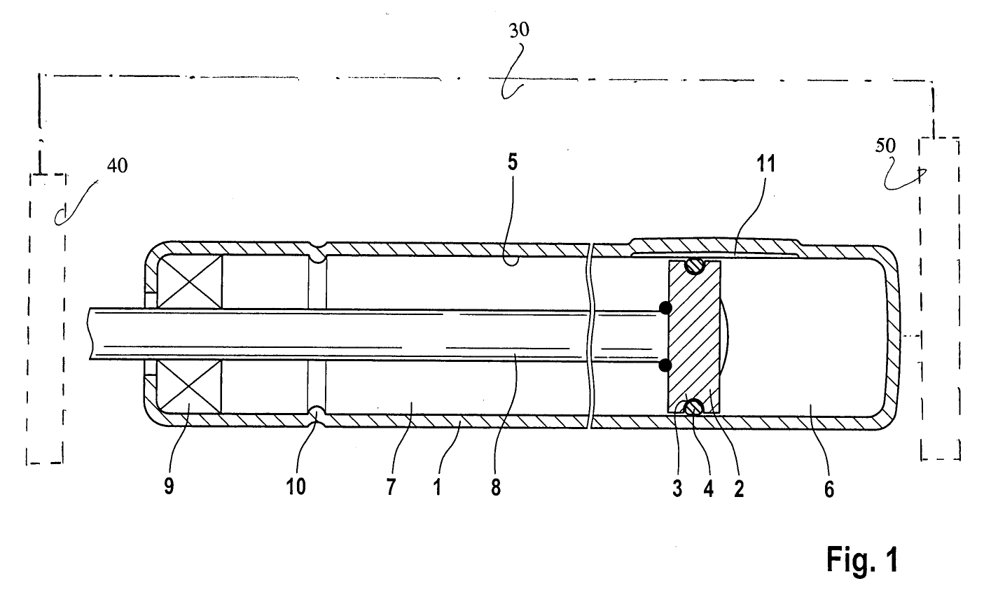

In the end area of the cylinder 1 near the closed end of the cylinder 1, a groove-like second recess 11 is formed in the inside wall 5 and configured to be slightly longer in the axial direction than the sealing area of the piston 2 formed by the sealing ring 4. Thus, when the piston rod 8 is in the retracted position shown in FIG. 1, which corresponds to the closed position of the hatch, the two working chamber 6 and 7 are connected to each other by the groove-like recess 11, so that the same pressure is present on both of the two chambers 6, 7. In this position, atmospheric pressure prevails in the air-filled chambers 6, 7.

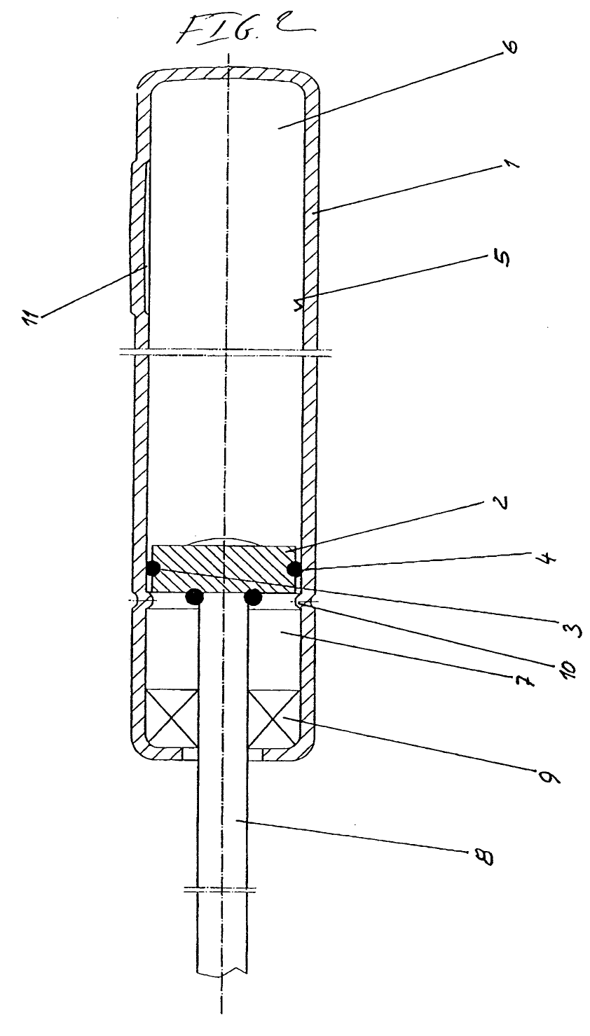

When the piston rod 8 together with the piston 2 travels outward into the position shown in FIG. 2, the piston 2 first leaves the area of the groove-like recess 11, so that the two working chambers 6, 7 are now separated from each other. As the outward movement continues, the air in the second working chamber 7 becomes compressed, and thus the pressure increases, whereas a negative pressure is produced in the first chamber 6. Both the positive pressure and the negative pressure increase until the piston rod reaches its maximum extension, shown in FIG. 2 and corresponding to the open position of the hatch.

A pressure differential between positive and negative pressures acting on the piston 2 produces a force which assists the closing movement during the subsequent closing of the hatch. The increase in the positive and negative pressures simultaneously produces a force which slows down the movement of the hatch.

To further improve smooth displacement of the hutch between its open and closed positions, the force produced by the tension spring can be combined with an action of an oil motion-damping element 30, which is diagrammatically sown in FIG. 1. The motion-damping element 20 is so linked between the linkage point 40 and the linkage point 50 (FIG. 1) that it acts parallel to the spring force. A good damping of the opening movement combined with a force assist during the closing of the hatch can be achieved by attaching one end of a motion-damping element acting in parallel with the tension spring.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

1. A tension spring arrangement for a hatch of a motor vehicle, comprising:
a cylinder for containing fluid, the cylinder having an inner cylindrical surface extending between spaced opposite open and closed ends of the cylinder;
a piston sealingly mounted in the cylinder so as to divide the inner cylindrical surface thereof into first and second chambers; and
a piston rod attached to the piston and extending through the open end of the cylinder for coupling to the hatch outside the cylinder, the piston and piston rod being reciprocally displaceable in the cylinder between an extended position of the piston rod and a retracted position thereof, the first and second chambers being in substantially pressure equilibrium in the retracted position of the rod; and
a seal mounted between the inner cylindrical surface of the cylinder and the piston rod adjacent to the open end of the cylinder.

2. The tension spring arrangement of claim 1, wherein the cylinder comprises:
a first recess providing continuous flow communication between the first chamber and atmosphere, and
a second recess terminating at a distance from the open end of the cylinder and in flow communication with the first recess so as to provide flow communication between the second chamber and the first recess as the piston and piston rod approach the retracted position.

3. The tension spring arrangement of claim 1, wherein the first and second chambers are in flow communication as the piston and piston rod approach the retracted position.

4. The tension spring arrangement of claim 1, wherein the first and second chambers are under substantially atmospheric pressure in the retracted position of the piston rod.

5. The tension spring arrangement of claim 1, wherein the cylinder has an outer surface spaced radially outwards from the inner cylindrical surface, the cylinder being provided with an elongated groove extending substantially parallel to a central axis of the cylinder between the inner cylindrical and outer surfaces thereof, the elongated groove being longer than a length of a sealing area between the inner cylindrical surface of the cylinder and an outer surface of the piston, the elongated groove opening into the inner cylindrical surface at two locations axially spaced from the closed and open ends of the cylinder, respectively, so as to provide flow communication between the first and second chambers while the piston approaches the retracted position of the piston rod.

6. The tension spring arrangement of claim 5, wherein the elongated groove has opposite end regions opening into the inner cylindrical wall of the cylinder at the axially spaced locations, respectively, one of the opposite end regions being closer to the closed end of the cylinder than the other end region to the open end.

7. The tension spring arrangement of claim 1, wherein the retracted position of the piston rod corresponds to a closed position of the hatch, and the extended position of the piston rod corresponds to an open position of the hatch.

8. The tension spring arrangement of claim 1, wherein the cylinder, the piston and the piston rod constitute a tension spring between the hatch and a linkage of a motor-vehicle body, the linkage of the motor-vehicle body being coupled to the closed end of the cylinder.

9. The tension spring arrangement of claim 8, further comprising a motion-damping element linked between the linkage of the motor-vehicle body and a linkage of a hinge or a multi-hinge joint of the hatch so that the tension spring and the motion-damping element operate parallel to one another.

10. The tension spring arrangement of claim 8, wherein the motion-damping element is an oil damper.
